(19) United States
(12) Patent Application Publication
(10) Pub. No.: US 2014/0176730 A1
(43) Pub. Date: Jun. 26, 2014

(54) PROJECTION-TYPE IMAGE DISPLAY DEVICE, IMAGE PROJECTION METHOD, AND COMPUTER PROGRAM

(71) Applicant: Sony Corporation, Tokyo (JP)

(72) Inventors: Yohsuke Kaji, Chiba (JP); Yoichi Hirota, Kanagawa (JP); Naomasa Takahashi, Chiba (JP); Noriyuki Yamashita, Tokyo (JP); Masaya Igarashi, Chiba (JP)

(73) Assignee: SONY CORPORATION, Tokyo (JP)

(21) Appl. No.: 14/102,972

(22) Filed: Dec. 11, 2013

(30) Foreign Application Priority Data
Dec. 21, 2012 (JP) 2012-278970

(51) Int. Cl. H04N 9/31; G06K 9/03; H04N 5/21

(52) U.S. Cl. CPC H04N 9/3191; H04N 5/21; G06K 9/036; H04N 9/3185
USPC 348/189

(57) ABSTRACT

There is provided a projection-type image display device including a projection section configured to project an image onto a projection body, a camera section, provided at a position different to an irradiation position of the projection section, configured to image the image projected onto the projection body, a correction amount detection section configured to remove a background from a test image imaged by the camera section at a time when a test pattern is projected onto the projection body from the projection section, detect information of coordinates related to the test pattern within the test image after background removal, and calculate correction parameters for correcting the image projected from the projection section based on the information of the coordinates, and an image correction section which corrects the image projected from the projection section based on the correction parameters.

### CROSS REFERENCE TO RELATED APPLICATIONS

This application claims the benefit of Japanese Priority Patent Application JP 2012-278970 filed Dec. 21, 2012, the entire contents of which are incorporated herein by reference.

### BACKGROUND

The technology disclosed in the present disclosure relates to a projection-type image display device, an image projection method, and a computer program which projects reproduced images of media, computer screens, or the like for display on a screen, and more specifically to a projection-type image display device, an image projection method, and a computer program which automatically corrects trapezoidal distortions and optical distortions of images projected onto a screen.

In recent years, opportunities have been increasing to make presentations which are appreciated by many people, by projecting images reproduced from media such as received images of television and Blu-ray Discs, or personal computer (PC) images, onto a large-sized screen by using a projection-type image display device. Further, small-sized projection-type image display devices (pico projectors) have also been appearing, which are intended to be used by being placing in the palm of the hand or installed in a mobile device.

When an image is projected onto a screen, there is a problem in which the image is distorted in a trapezoidal shape in order to be projected from the diagonal with respect to a projection body (a screen wall or the like). An automatic correction function of trapezoidal distortions is in general a function which corrects trapezoidal distortions, by projecting a test pattern on a screen, imaging an image of the test pattern projected onto the screen with a built in camera, and obtaining three-dimensional information of the screen based on the obtained four corner positions of the screen and the four corner positions of the test pattern (for example, refer to JP 2007-13810A). In the case where an image projected onto a screen is distorted in a trapezoidal shape in the vertical direction, the projected image can be made to become a clear-cut quadrilateral on the screen, by intentionally distorting the displayed image on an image display device in the opposite direction to that of the trapezoidal distortions of the projected image on the screen.

However, in order to accurately correct trapezoidal distortions by using a test pattern projected onto a screen, it may be necessary to capture a projected image with a camera which is clearer than that of the test pattern. Accordingly, there may be problems such as trapezoidal distortions not being able to be accurately corrected if not performed in a dark room or on a completely white screen, and malfunctions occurring by interference from outside light such as natural light. That is, the environment in which a projection-type image display device can be used is limited. For example, while a pico projector can be carried anywhere due to its small size, this attractiveness is lost when the locations of use are restricted.

### SUMMARY

It is desirable for the technology disclosed in the present disclosure to provide an excellent projection-type image display device, image projection method, and computer program which can suitably and automatically correct various distortions, such as trapezoidal distortions, occurring in a projected image, by using a test pattern projected onto a screen.

It is further desirable for the technology disclosed in the present disclosure to provide an excellent projection-type image display device, image projection method, and computer program which can suitably and automatically correct trapezoidal distortions of a projected image, even in the case of projecting in an environment interfered by outside light and projecting onto a projection body which is not completely white.

According to an embodiment of the present technology, there is provided a projection-type image display device including a projection section configured to project an image onto a projection body, a camera section, provided at a position different to an irradiation position of the projection section, configured to image the image projected onto the projection body, a correction amount detection section configured to remove a background from a test image imaged by the camera section at a time when a test pattern is projected onto the projection body from the projection section, detect information of coordinates related to the test pattern within the test image after background removal, and calculate correction parameters for correcting the image projected from the projection section based on the information of the coordinates, and an image correction section which corrects the image projected from the projection section based on the correction parameters.

The correction amount detection section may calculate coordinates of a plurality of characteristic points of the test pattern from the test image after background removal, and calculate, from the coordinates of the plurality of characteristic points, projective transformation parameters for correcting distortions included in the projected image of the photographic subject. The image correction section may perform projective transformation on the image projected from the projection section by the projective transformation parameters.

The camera section may image a first test image at a time when the test pattern is not irradiated from the projection section, and image a second test image at the time when the test pattern is irradiated from the projection section. The correction amount detection section may remove information of a background from the second test image, by creating a difference between the first test image and the second test image, and obtain the test image after background removal in which the test pattern is included.

The camera section may image a first test image at a time when a first test pattern is irradiated from the projection section, and image a second test image at a time when a second test pattern is irradiated from the projection section. The correction amount detection section may remove information of a background from the first test image and the second test image, by creating a difference between the first test image and the second test image, and obtain the test image after background removal including a test pattern in which the first test pattern and the second test pattern are synthesized.

The correction amount detection section may perform a removal process of information of a background after performing an illuminance adjustment between the first test image and the second test image.

The correction amount detection section may perform the luminance adjustment process by multiplying a ratio of an average luminance based on one of the first test image and the second test image by pixel values of the other image.

The correction amount detection section may perform the luminance adjustment process for each area in which the first test image and the second test image are divided into a horizontal and a vertical direction, respectively.

The correction amount detection section may standardize luminance for areas which include the test pattern from within the test image after background removal.

The correction amount detection section may standardize luminance only for areas in which dispersion values of pixel values from within the test image are equal to or more than a prescribed threshold.

A mesh shaped test pattern may be used which includes a plurality of vertical lines and a plurality of horizontal lines. The correction amount detection section calculates projective transformation parameters for correcting distortions based on coordinates of a plurality of characteristic points including each intersection point of vertical lines and horizontal lines of the test pattern included in the test image after background removal. The image correction section may perform projective transformation on the image projected from the projection section by the projective transformation parameters.

The test pattern may further include two slits corresponding to diagonal lines of a rectangle which becomes an outline of the test pattern.

The correction amount detection section may estimate a largest image size which can be projected onto the projection body from the projection section based on coordinates of characteristic points which can be detected from the test image after background removal.

A first test pattern including a plurality of vertical lines and a second test pattern including a plurality of horizontal lines may be used. The correction amount detection section may calculate projective transformation parameters for correcting distortions based on coordinates of a plurality of characteristic points including each intersection point of vertical lines and horizontal lines of the test pattern included in the test image after background removal. The image correction section may perform projective transformation on the image projected from the projection section by the projective transformation parameters.

The correction amount detection section may estimate a largest image size which can be projected onto the projection body from the projection section based on coordinates of characteristic points which can be detected from the test image after background removal.

After performing a noise reduction process by additional autocorrelation for a test image after information of a background is removed, the correction amount detection section may detect information of coordinates of each characteristic point related to the test pattern within the test image, and calculate correction parameters based on information of the coordinates of each characteristic point.

After performing a noise reduction process by angle searching the test image including the test pattern of a plurality of vertical lines or a plurality of horizontal lines in a vertical direction or a horizontal direction, the correction amount detection section may calculate coordinates of a plurality of characteristic points including each intersection point of vertical lines and horizontal lines of the test pattern, and calculate projective transformation parameters for correcting distortions based on information of the coordinates of each intersection point.

The correction amount detection section may detect each test pattern of vertical lines or horizontal lines included in the test image as a two-dimensional curved line.

The correction amount detection section may perform an angle search by setting, as a center, a result of an adjacent segment to which an angle search has been performed immediately before.

Further, according to an embodiment of the present technology, there is provided an image projection method including projecting a test pattern onto a projection body, acquiring a test image by imaging the test pattern projected onto the projection body, removing a background from the test image, detecting information of coordinates related to the test pattern included in the test image after background removal, and calculating correction parameters for correcting an image projected from a projection section based on information of the coordinates, and correcting the projected image based on the correction parameters.

Further, according to an embodiment of the present technology, there is provided a computer program written in a computer-readable format so as to cause a computer to execute projecting a test pattern onto a projection body, acquiring a test image by imaging the test pattern projected onto the projection body, removing a background from the test image, detecting information of coordinates related to the test pattern included in the test image after background removal, and calculating correction parameters for correcting an image projected from a projection section based on information of the coordinates, and correcting the projected image based on the correction parameters.

A computer program according to an embodiment of the present disclosure defines a computer program written in a computer-readable format so as to implement prescribed processes on a computer. In other words, by installing a computer program according to an embodiment of the present disclosure in a computer, cooperative functions can be produced on the computer, and operation effects can be obtained similar to those of the image projection method according to an embodiment of the present disclosure.

According to the technology disclosed in the present disclosure, an excellent projection-type image display device, image projection method, and computer program can be provided which can suitably and automatically correct various distortions, such as trapezoidal distortions, occurring in a projected image, by using a test pattern projected onto a screen.

Further, according to the technology disclosed in the present disclosure, an excellent projection-type image display device, image projection method, and computer program can be provided which can suitably and automatically correct trapezoidal distortions of a projected image, even in the case of projecting in an environment interfered by outside light and projecting onto a projection body which is not completely white.

It is further desirable for the features and advantages of the technology disclosed in the present disclosure to be clarified by a more detailed description based on the attached embodiments and figures, which will be described later.

### BRIEF DESCRIPTION OF THE DRAWINGS

FIG. 1 is a figure which schematically shows a configuration of a projection-type image display device 100 according to an embodiment of the technology disclosed in the present disclosure;

FIG. 2 is a figure which shows an internal configuration example of a projection section 101;

FIG. 3 is a figure which shows an internal configuration example of an image processing section 102;

FIG. 4 is a figure which shows an internal configuration example of a correction amount detection section 105;

FIG. 5A is a figure which shows an example of a test pattern used for calculating projective transformation parameters which correct distortions of a projected image;

FIG. 5B is a figure which shows another example of a test pattern used for calculating projective transformation parameters which correct distortions of a projected image;

FIG. 5C is a figure which shows another additional example of a test pattern used for calculating projective transformation parameters which correct distortions of a projected image;

FIG. 5D is a figure for describing a process which calculates projective transformation parameters by using the test pattern shown in FIG. 5C;

FIG. 5E is a figure which shows another example of a first test pattern used for calculating projective transformation parameters which correct distortions of a projected image;

FIG. 5F is a figure which shows another example of a second test pattern used for calculating projective transformation parameters which correct distortions of a projected image;

FIG. 5G is a figure which shows a modified example of the test pattern described in FIG. 5C;

FIG. 5H is a figure which shows a modified example of the first test pattern shown in FIG. 5E;

FIG. 5I is a figure which shows a modified example of the second test pattern shown in FIG. 5F;

FIG. 5J is a figure which shows a state in which an average luminance A_Area(0,1) is obtained in an area Area(0,1) of a first test image A imaged by irradiating the first test pattern shown in FIG. 5H;

FIG. 5K is a figure which shows a state in which an average luminance B_Area(0,1) is obtained in an area Area(0,1) of a second test image B imaged by irradiating the second test pattern shown in FIG. 5H;

FIG. 6 is a flow chart which shows a process procedure for correcting trapezoidal distortions of a projected image to a projection body, in the projection-type image display device 100;

FIG. 7A is a figure which shows an example of a first test image A imaged at the time when a first test pattern including two vertical and horizontal lines is irradiated onto a projection body;

FIG. 7B is a figure which shows an example of a second test image B imaged at the time when a second test pattern including two vertical and horizontal lines is irradiated onto a projection body;

FIG. 8A is a figure which shows a background removed image C obtained by subtracting a second test image B from a first test image A;

FIG. 8B is a figure which shows a background removed image D obtained by subtracting a first test image A from a second test image B;

FIG. 9A is a figure for describing a process which performs an angle search and noise reduction for a background removed image;

FIG. 9B is a figure for describing a process which performs an angle search and noise reduction for a background removed image;

FIG. 9C is a figure for describing a process which performs an angle search and noise reduction for a background removed image;

FIG. 9D is a figure for describing a process which performs an angle search and noise reduction for a background removed image;

FIG. 10A is a figure which shows a background removed image C2 obtained by performing a powerful noise reduction process by an autocorrelation for a background removed image C;

FIG. 10B is a figure which shows a background removed image D2 obtained by performing a powerful noise reduction process by an autocorrelation for a background removed image D;

FIG. 11A is a figure for describing a process which obtains intersection points by detecting four segments included in the background removed images C2 and D2 as a two-dimensional curved line;

FIG. 11B is a figure for describing a process which obtains intersection points by detecting four segments included in the background removed images C2 and D2 as a two-dimensional curved line;

FIG. 11C is a figure for describing a process which obtains intersection points by detecting four segments included in the background removed images C2 and D2 as a two-dimensional curved line;

FIG. 12 is a figure which shows a state in which pin-cushion type distortions occur in a projected image to a photographic subject; and

FIG. 13 is a figure which shows a state in which barrel type distortions occur in a projected image to a photographic subject.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

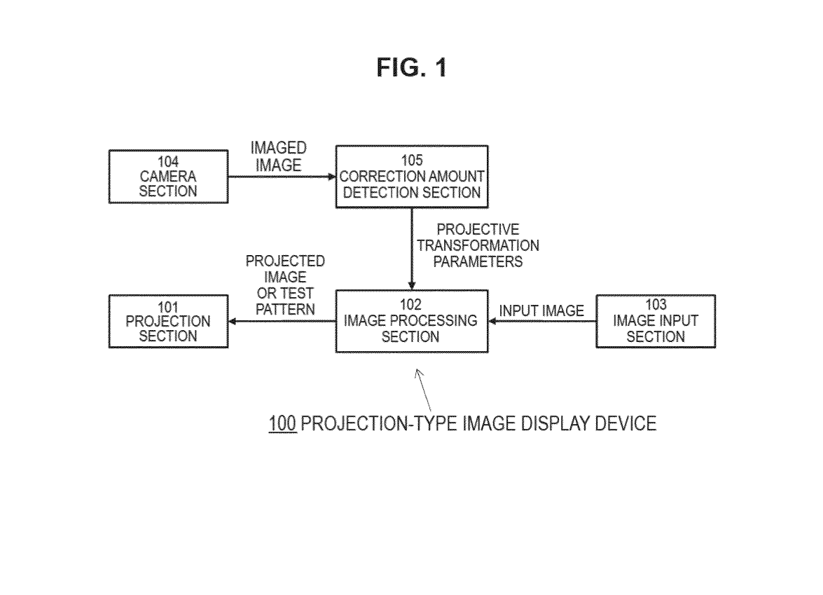

FIG. 1 schematically shows a configuration of a projection-type image display device 100 according to an embodiment of the technology disclosed in the present disclosure. The projection-type image display device 100 shown in the figure includes a projection section 101, an image processing section 102, an image input section 103, a camera section 104, and a correction amount detection section 105. Hereinafter, each of the sections will be described.

The image input section 103 inputs image signals from a supply source of projected images such as a personal computer, a TV receiver, or a Blu-ray Disc reproducing device (none of which are shown in the figure).

The image processing section 102 performs processes of the images projected and output from the projection section 101. An image output from the image processing section 102 is a test pattern generated within the image processing section 102, with an external image supplied from the image input section 103. Within the image processing section 102, distortion correction of the projected image is performed, based on correction parameters supplied from the correction amount detection section 105. Other than trapezoidal distortions based on a three-dimensional position relation between the projection section 101 and the projection body, the distortions to be corrected also include optical distortions which originate in the optical system of the projection section 101 and the camera section 104.

The projection section 101 projects an image output from the image processing section 102 onto a projection body such as a screen (not shown in the figure). Trapezoidal distortions are generated in the projected image, due to projecting from a direction which is diagonal with respect to a photographic subject (a screen wall) from the projection section 101.

The camera section 104 images the test pattern projected onto the projection body from the projection section 101. By using the test pattern image projected by the camera 104, the correction amount detection section 105 calculates a correction amount for correcting the above described trapezoidal distortions and optical distortions, which are included in the projected image from the projection section 101, and outputs the calculated correction amount to the image processing section 102. The trapezoidal distortions and optical distortions can be corrected by performing a projective transformation for the output image. In the present embodiment, the correction amount detection section 105 calculates projective transformation parameters as the correction amount.

In the present embodiment, the camera section 104 is arranged at a position different to that of an irradiation position of the projection section 101, and an optical axis is set so that an imaging range includes an irradiation range of the projection section 101 as much as possible. When a specific test pattern is irradiated from the projection section 101, the test pattern is imaged by the camera section 104. Also, from the imaged image, the correction amount detection section 105 obtains a distance and direction up to the projection body, calculates projective transformation parameters, and outputs the calculated projective transformation parameters to the image processing section 102. Afterwards, all the images input from the image input section 103 by the image processing section 102 are projection converted by the projective transformation parameters, and an image in which the trapezoidal distortions and optical distortions are corrected is irradiated from the projection section 101.

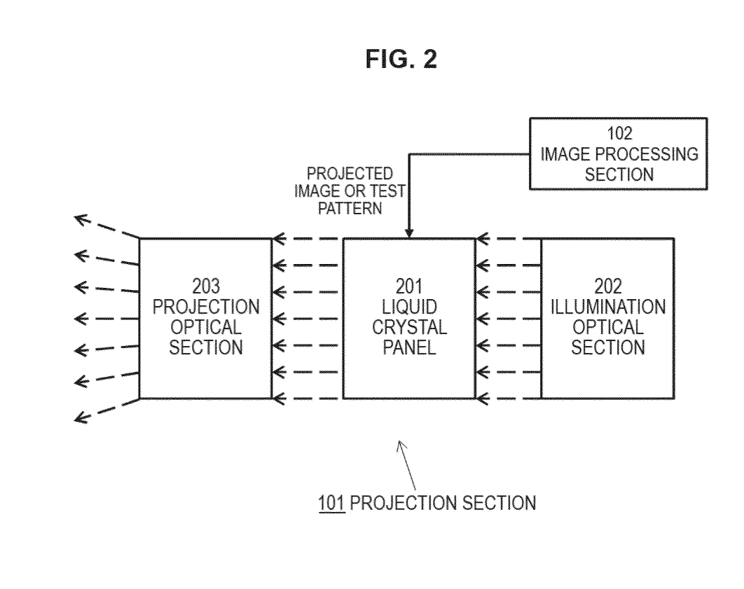

FIG. 2 shows an internal configuration example of the projection section 101. The projection section 101 shown in the figure includes a liquid crystal panel 201, an illumination optical section 202, a liquid crystal panel driving section 204, and a projection optical section 203.

The liquid crystal panel driving section 204 drives the liquid crystal panel 201 based on image signals input from the image processing section 102, and draws a projected image on a display screen. The illumination optical section 202 irradiates the liquid crystal panel 201 from a rear surface. In the case were the projection-type image display device 100 is a pico projector, an LED (Light Emitting Diode) or laser is used, for example, for the light source of the illumination optical section 202. The projection optical section 203 enlarges and projects light penetrating the liquid crystal panel 201 onto a projection body (not shown in the figure). An input image to the image input section 103, or a test pattern generated within the projection-type image display device 100, is projected from the projection section 101. The projection optical section 203 includes one, or two or more, optical lenses. It is assumed that the projection optical section 203 has lens distortions, and accordingly, optical distortions other than trapezoidal distortions will also occur in a projected image.

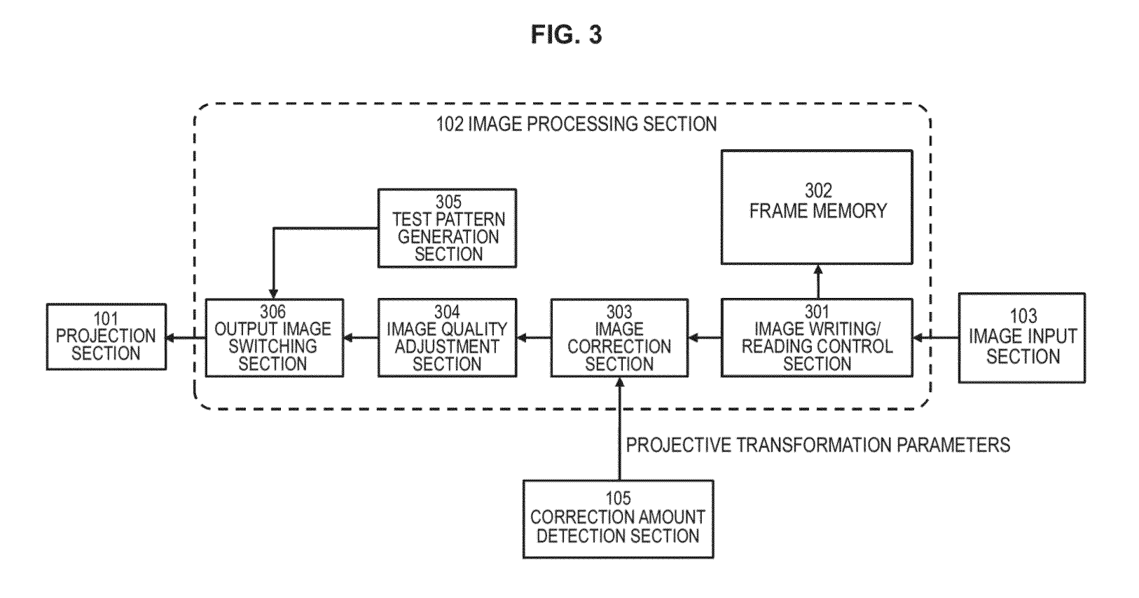

FIG. 3 shows an internal configuration example of the image processing section 102. The image processing section 102 shown in the figure includes an image writing/reading control section 301, a frame memory 302, an image correction section 303, an image quality adjustment section 304, a test pattern generation section 305, and an output image switching section 306.

Images supplied from the image input section 103 are stored in the frame memory 302. The image writing/reading control section 301 controls the writing and reading of image frames to the frame memory 302.

The image correction section 303 projects and converts an image read from the frame memory 302, based on projective transformation parameters received from the correction amount detection section 105, and performs correction so that trapezoidal distortions are eliminated when projecting onto a photographic subject from the projection section 101.

The image quality adjustment section 304 performs image quality adjustments, such as for luminance, contrast, synchronization, tracking, color density and shading, so that a projected image is in a desired display condition after distortion correction has been performed.

The test pattern generation section 305 generates a test pattern used when projective transformation parameters are calculated by the correction amount detection section 105. The test pattern has a geometric shape in which three-dimensional information of a screen, which is the projection body, is obtained easily. The types of test patterns used will be described later.

The output image switching section 306 performs switching of the images output to the projection section 101. For example, at the time when a presentation or the like is performed by projecting, to a projection body, an input image from an image supply source such as a personal computer, a TV receiver or a Blu-ray Disc reproducing device (none of which are shown in the figure), the output image switching section 306 outputs an output image from the image quality correction section 304 to the projection section 101. Further, at the time when projective transformation parameters are calculated for correcting trapezoidal distortions and optical distortions of the projected image, the output image switching section 306 outputs a test pattern generated by the test pattern generation section 305 to the projection section 101.

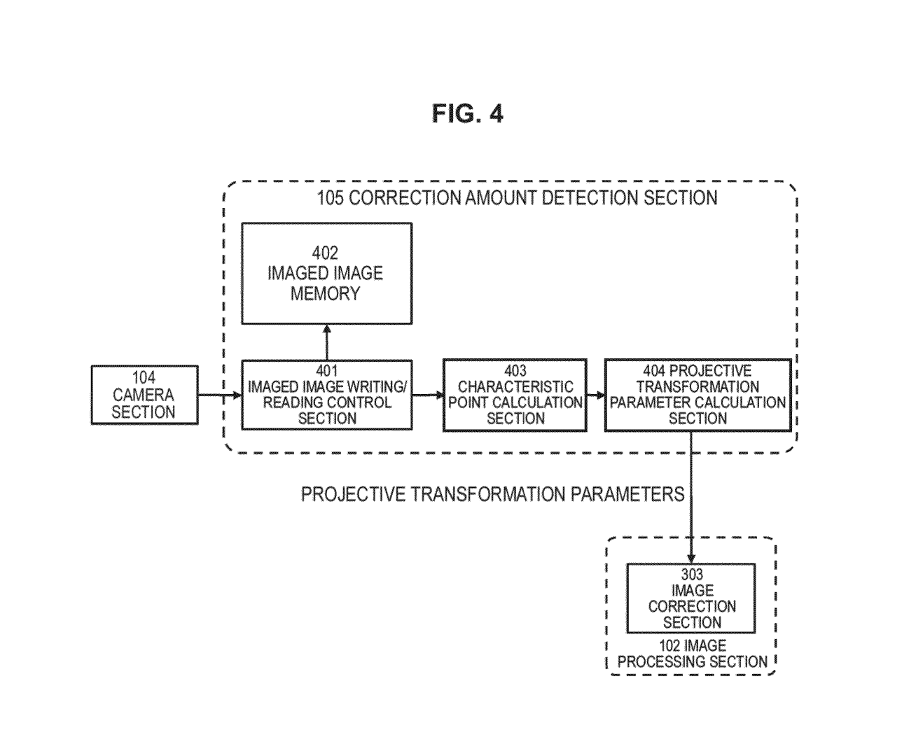

FIG. 4 shows an internal configuration example of the correction amount detection section 105. The correction amount detection section 105 shown in the figure includes an imaged image writing/reading control section 401, an imaged image memory 402, a characteristic point calculation section 403, and a projective transformation parameter calculation section 404.

The imaged image memory 402 stores imaged images of the camera section 104. In the present embodiment, the imaged image memory 402 has a size just for storing imaged images of the camera section 104 for at least two frame parts.

The imaged image writing/reading control section 401 controls the writing and reading of imaged images to the imaged image memory 402.

The characteristic point calculation section 403 obtains coordinates of characteristic points such as the four corners of a test pattern included in the imaged image, by using the imaged image read from the imaged image memory 402. Also, the projective transformation parameter calculation section 404 obtains a distance and direction up to the projection body from the projection section 101, based on the calculated coordinates of the characteristic points, and calculates projective transformation parameters for correcting trapezoidal distortions and optical distortions of the image projected onto the projection body.

In order to calculate a correction amount of the trapezoidal distortions and optical distortions by using the test pattern projected onto the projection body, it may be necessary to extract clearer information of the test pattern. Accordingly, if not performed in a dark room or on a completely white screen, there is the possibility of malfunctions occurring due to interference from outside light such as natural light. For example, in the case where the projection-type image display device 100 is a pico projector, in order to obtain advantages such as being able to use by carrying anywhere, information of a test pattern on a screen which has a pattern may have to be correctly extracted. On the other hand, in the present embodiment, at the time when information of a test pattern is extracted from an imaged image of the camera section 104, information of the background is removed, and in this way, automatic correction of trapezoidal distortions and optical distortions is achieved, even in the case of projecting in an environment interfered by outside light and projecting onto a projection body which is not completely white.

In order for information of the background to be removed, in the present embodiment, imaging is performed two times by the camera section 104. For example, a first test image imaged without irradiating the test pattern, and a second test image imaged by irradiating the test pattern are stored in the imaged image memory 402, while keeping the same background. Or, a first test image imaged at the time when a first test pattern is irradiated, and a second test image imaged at the time when a second test pattern different to the first test pattern is irradiated are stored in the imaged image memory 402. Also, the characteristic point calculation section 403 removes information of the background, by creating a difference between the first test image and the second test image read from the imaged image memory 402, and information of the test pattern, in which the first test pattern and the second test pattern are synthesized, is made clear. In this way, the coordinates of characteristic points such as the four corners of a test pattern are correctly calculated, even in the case of projecting in an environment interfered by outside light and projecting a test pattern onto a projection body which is not completely white (has a pattern), and projective transformation parameters can be performed for correcting trapezoidal distortions and optical distortions without malfunctions occurring.

Here, in order for the characteristic point calculation section 403 to produce coordinates of characteristic points such as the four corners of a test pattern, it is preferable that the test pattern generated by the test pattern generation section 305 includes two horizontal lines and two vertical lines.

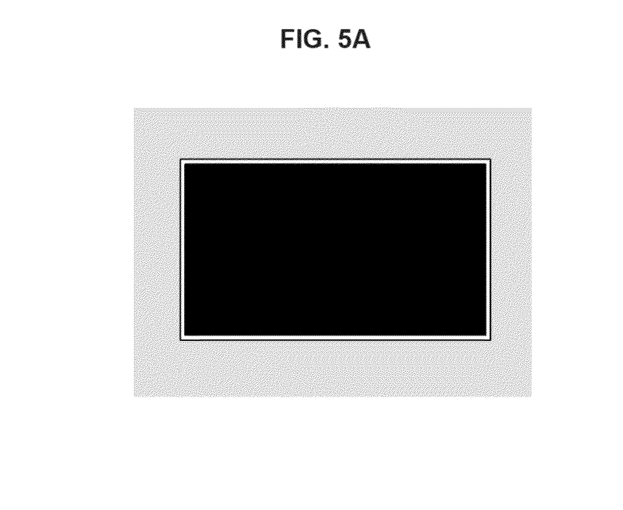

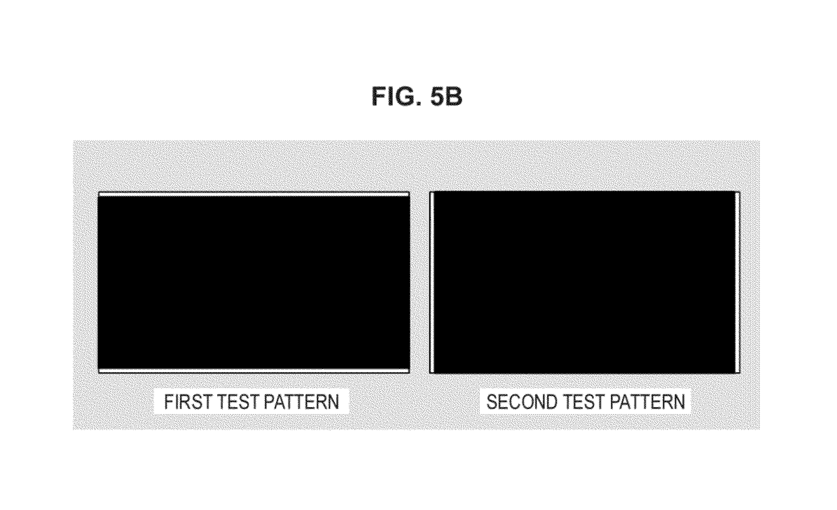

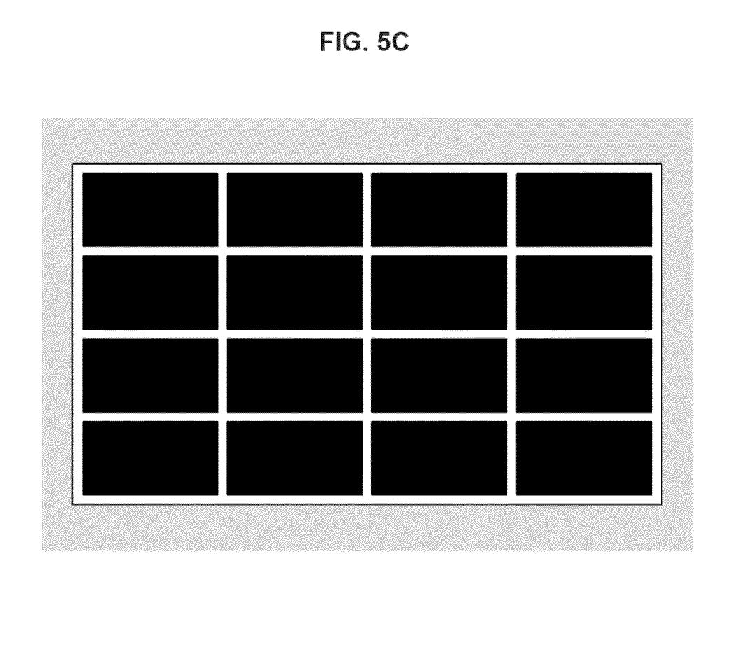

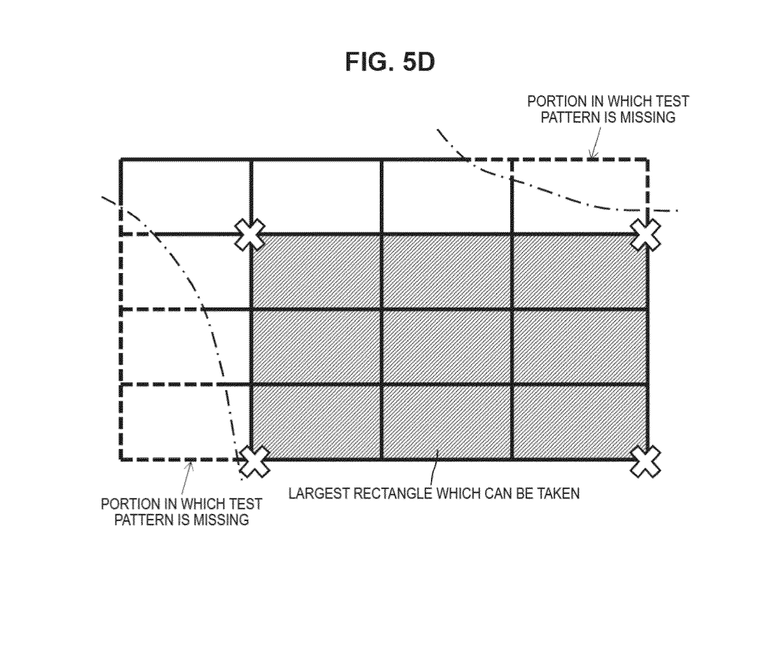

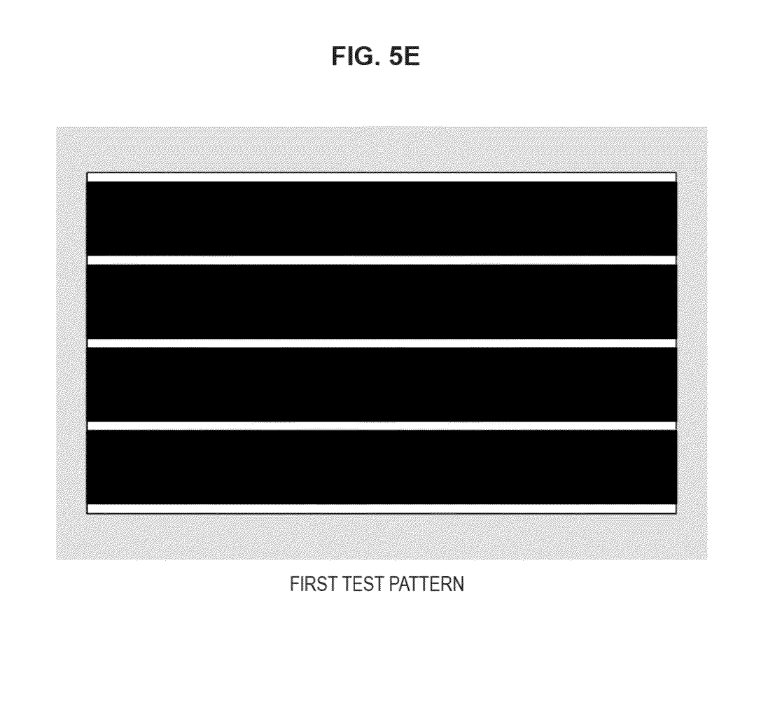

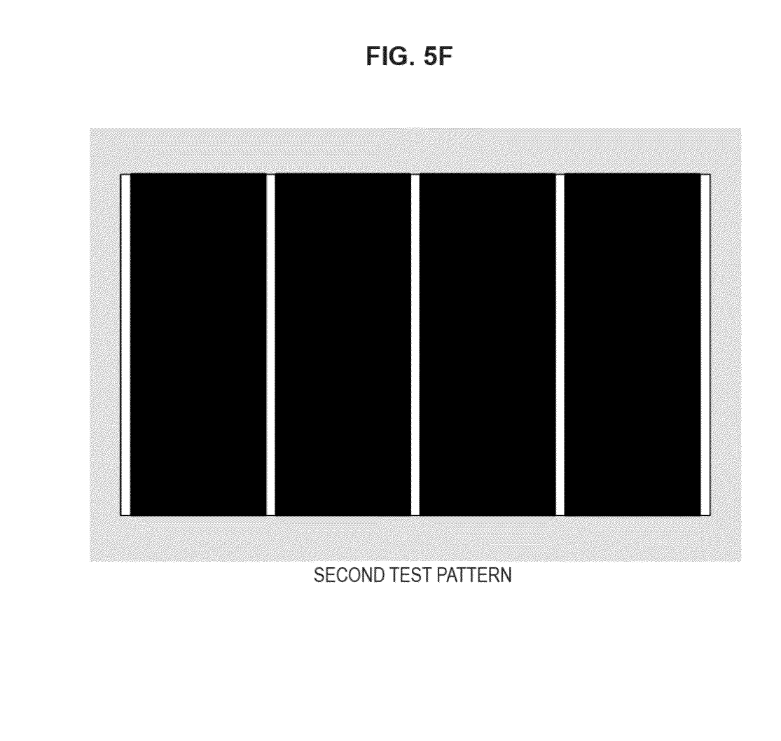

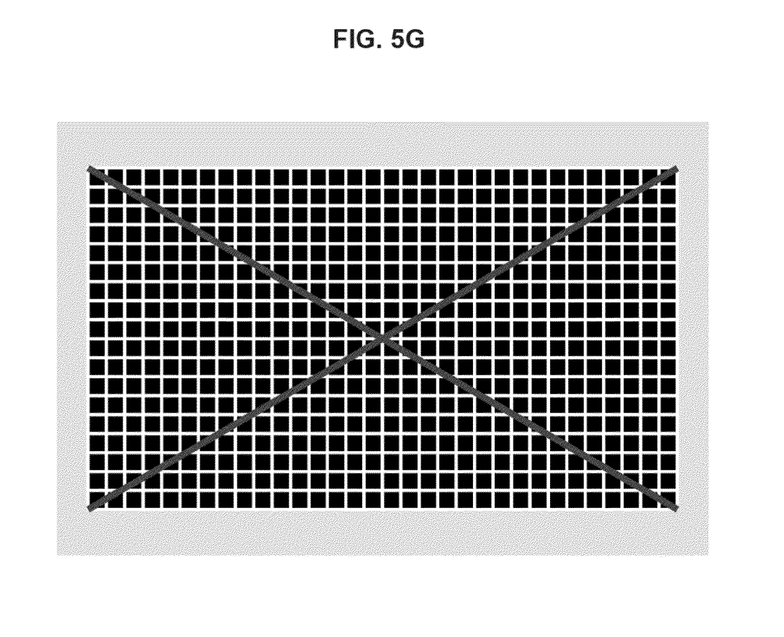

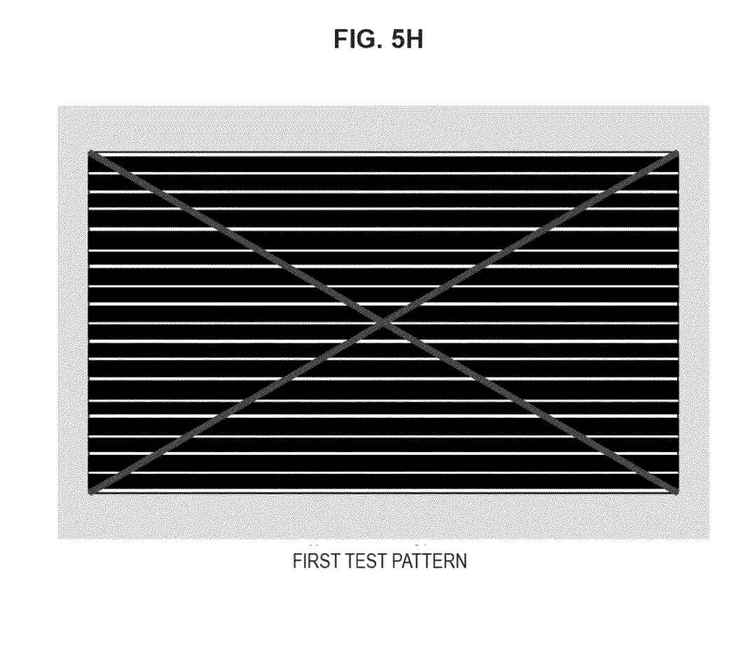

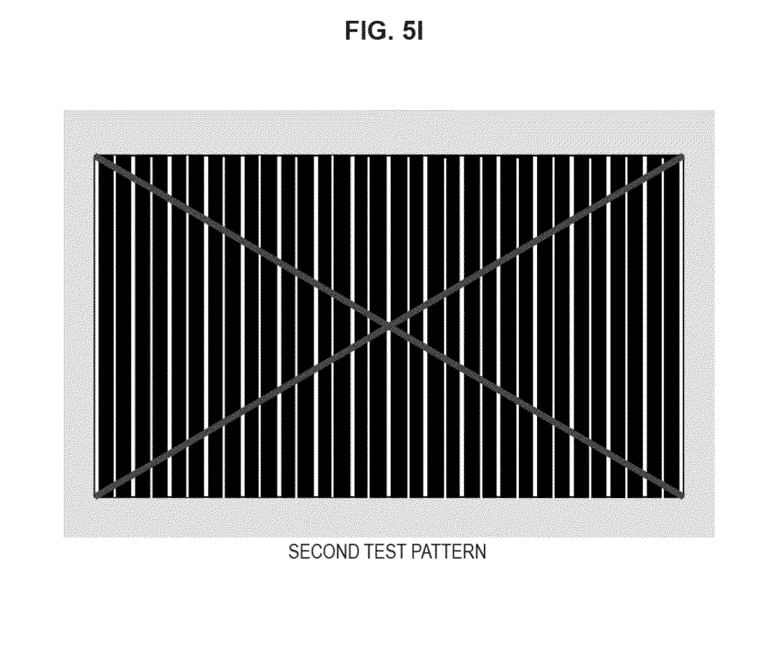

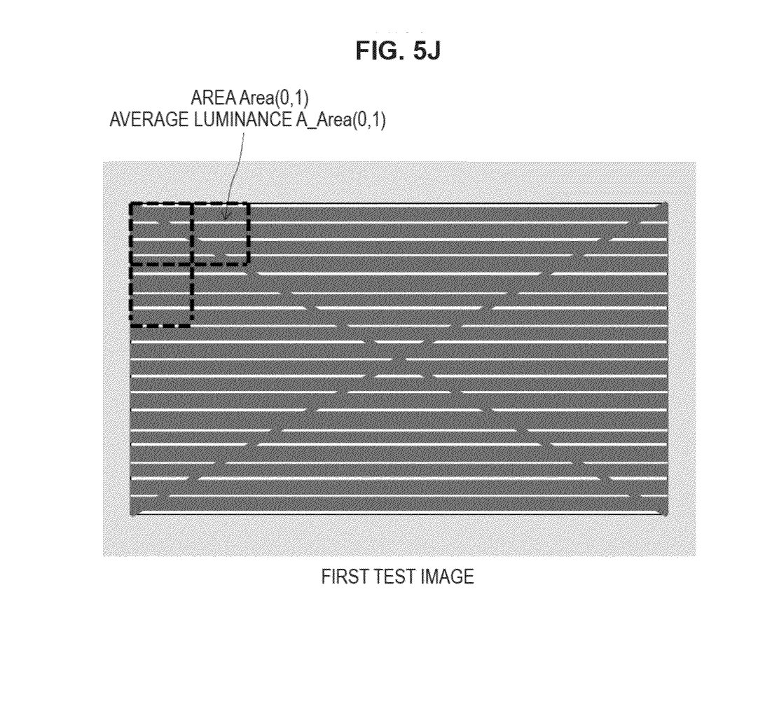

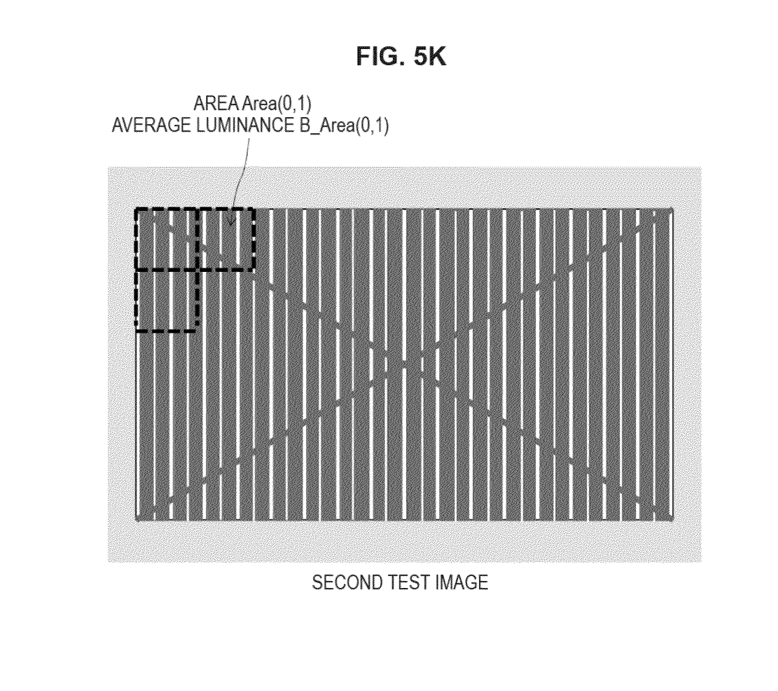

For example, such as shown in FIG. 5A, in the case where a test pattern is used which is rectangular along the approximate periphery of the irradiation range of the projection section 101, a first test image not irradiating the test pattern is imaged, a second test image irradiating the test pattern is imaged, and if information of the background is removed, by creating a difference between the first test image and the second test image, information of the test pattern can be made clearer.

Further, such as shown in the left part of FIG. 5B, a first test pattern may be used which includes two horizontal lines along each of the top and bottom edges of the irradiation range of the projection section 101, and such as shown in the right part of FIG. 5B, a second test pattern may be used which includes two vertical lines along each of the left and right edges of the irradiation range of the projection section 101. In this case, the first test image irradiating the first test pattern is imaged, the second test image irradiating the second test pattern is imaged, and if information of the background is removed, by creating a difference between the first test image and the second test image, a test pattern which becomes a rectangle along the approximate periphery of the irradiation range of the projection section 101 can similarly be made clearer. A rectangular test pattern, in which the first test pattern and the second test pattern are synthesized (that is, similar to the test pattern shown in FIG. 5A), is included in the test image after background removal. Also, when coordinates of characteristic points such as the four corners of this rectangular test pattern are obtained, the projective transformation parameter calculation section 404 obtains a distance and direction up to the projection body from the projection section 101, based on this coordinate information, and can calculate projective transformation parameters for correcting trapezoidal distortions of the image projected onto the projection body.

For example, for a displayed image of the liquid crystal panel 201, which includes a test pattern with 630×360 pixels, a line width of the horizontal lines and vertical lines arranged in the periphery part are 6 pixels, for example.

If only the coordinates for the four corners of the irradiation range of the projection section 101 are extracted as characteristic points, trapezoidal distortions can be corrected. Further, if not only the coordinates for the four corners of the irradiation range of the projection section 101 are taken from the test pattern, but also the coordinates of more characteristic points are taken, more detailed distortion correction can be performed for not only trapezoidal distortions of the entire image of the projected image, but for also distortions occurring locally. Therefore, the test pattern (or a combination of the first test pattern and the second test pattern) may be constituted not only by two horizontal lines and two vertical lines, but by a combination of three or more horizontal lines and three or more vertical lines.

For example, in the case where a test pattern is used which is constituted by a combination of three or more horizontal lines and three or more vertical lines such as that shown in FIG. 5C, a first test image not irradiating the test pattern is imaged, a second test image irradiating the test pattern is imaged, and if information of the background is removed, by creating a difference between the first test image and the second test image, information of a mesh shaped test pattern, in which the three or more horizontal lines and the three or more vertical lines intersect one another, can be made clearer.

Further, such as shown in FIG. 5E, a first test pattern constituted of three or more horizontal lines may be used, and such as shown in FIG. 5F, a second test pattern constituted of three or more vertical lines may be used. In this case, a first test image irradiating the first test pattern is imaged, a second test image irradiating the second test pattern is imaged, and if information of the background is removed, by creating a difference between the first test image and the second test image, information of a similar test pattern can be made clearer. A mesh shaped test pattern, in which the first test pattern and the second test pattern are synthesized (that is, the same as the test pattern shown in FIG. 5C), can be included in the test image after background removal.

Here, there are cases where a part of the test pattern projected from the projection section 101 is missing, due to circumstances such as the area of the projection body being smaller than the irradiation range of the projection section 101 (or the area of a flat portion being narrow). FIG. 5D shows missing areas, by dotted lines, from within the mesh shaped test pattern shown in FIG. 5C (or, the combination of the test patterns shown in FIG. 5E and FIG. 5F). At the time when all of such a mesh shaped test pattern is not able to be used for the calculation of projective transformation parameters, the characteristic point calculation section 403 may calculate coordinates of the four corners of a largest rectangle which can be taken from the test pattern usually projected onto the projection body, and the projective transformation parameter calculation section 404 may calculate projective transformation parameters by using the coordinates of the four corners of this largest rectangle.

Within FIG. 5D, the characteristic point calculation section 403 calculates the four corners (within the figure, the four intersection points shown by X) of the largest rectangle (within the figure, the area drawn by diagonal lines) taken from the test pattern usually projected. Also, the projective transformation parameter calculation section 404 may be used for the calculation of projective transformation parameters for trapezoidal distortion correction by using these four corner points.

FIG. 5G shows a modified example of the test pattern shown in FIG. 5C. A first test image not irradiating the test pattern is imaged, a second test image irradiating the test pattern is imaged, and if information of the background is removed, by creating a difference between the first test image and the second test image, information of a detailed mesh shaped test pattern can be made clearer. Further, FIG. 5H shows a modified example of the first test pattern shown in FIG. 5E, and FIG. 5I shows a modified example of the second test pattern shown in FIG. 5F. In this case, a first test image irradiating the first test pattern is imaged, a second test image irradiating the second test pattern is imaged, and if information of the background is removed, by creating a difference between the first test image and the second test image, information of the test pattern can similarly be made clearer. A mesh shaped test pattern, in which the first test pattern and the second test pattern are synthesized (that is, similar to the test pattern shown in FIG. 5G), is included in the test image after background removal.

As shown in FIGS. 5G to 5I, when the test pattern is made into a more detailed mesh shape, the largest rectangle which can be taken from the test pattern can be estimated with high accuracy, in the case where a part of the test pattern projected from the projection section 101 is missing, due to circumstances such as the area of the projection body being smaller than the irradiation range of the projection section 101 (or the area of a flat portion being narrow). The characteristic point calculation section 403 may calculate projective transformation parameters, by using the characteristic points of the four corners of the estimated largest rectangle. Further, since it can be easily detected up to where the test pattern is irradiated on the screen, by detecting a characteristic point from the test image after background removal, it becomes possible to estimate the largest image size which can be irradiated onto the screen. The image correction section 303 may perform distortion correction of the projected image by using projective transformation parameters, and may perform a size adjustment of the projected image by matching the largest image size.

Further, the test patterns shown in FIGS. 5G to 5I may each include two slits dividing the mesh or the horizontal lines and vertical lines of the test pattern, which correspond to the diagonal lines of a rectangle which becomes an outline of the test pattern. The intersection point of the slits corresponds to the approximate center of the test pattern. Therefore, on the basis of the intersection point of the slits, the position of the largest range of the test pattern irradiated onto the screen (whether it can be detected up to a numbered intersection point up and down or left and right) can be easily obtained.

As has been described up to here, in the present embodiment, the background is removed by taking a difference between a first test image and a second test image, and a clearer test pattern is obtained. However, in a system in which a user is not able to determine the influence of outside light or the exposure of imaging (in the case where the camera section 104 is not able to be controlled or the camera section 104 is not released to the user), there are cases where the luminance will significantly differ between the first test image and the second test image. When there is a luminance difference between imaged test images, removing only the background by taking a difference is not able to be performed with high accuracy.

Accordingly, after performing an adjustment in which the luminance is matched between the first test image and the second test image, the characteristic point calculation section 403 performs background removal by taking a difference. For example, one of the test images is set as a standard, and a process is performed in which a ratio of average luminance is multiplied by the pixel values of the other test image. Further, local luminance adjustment is performed, by considering not only a uniform luminance difference which occurs over the entire imaged image, but also the local luminance differences which occur.

Specifically, an average luminance is obtained for each of the areas where each test image has been divided into a plurality of images in both the horizontal and vertical directions. Also, the ratio of an average luminance based on one test image is calculated, by the areas corresponding to each test image, and the calculated ratio is multiplied by the pixel values of the other image.

FIG. 5J shows a state in which a first test image A imaged by irradiating the first test pattern shown in FIG. 5H is divided into a plurality of images in the horizontal and vertical directions, and an average luminance A_Area(0,1) is obtained in an area Area(0,1) of the 0^{th} line and 1^{st} column. Similarly, FIG. 5K shows a state in which an average luminance B_Area(0,1) is obtained in an area Area(0,1) of the 0^{th} line and 1^{st} column of a second test image B imaged by irradiating the second test pattern shown in FIG. 5I.

Also, when a ratio Scale of an average luminance based on the first test image A is calculated in accordance with the following Equation (1), a second test image B′ after luminance adjustment is obtained, such as shown in the following Equation (2), by multiplying this average ratio Scale by the pixel values of each pixel within the same area Area(0,1) of the second test image B.

Scale=Average luminance A_Area(0,1)/Average luminance B_Area(0,1) (1)

Test image B′=Scale×Test image B (2)

The characteristic point calculation section 403 performs standardization of the luminance for the image after the background is removed by taking a difference between the first test image and the second test image. However, in the case where the projection body is in a bright environment, the luminance of a test pattern which can be imaged by the camera section 104 will become low. When the luminance of a background removed image is standardized by this matching, there are problems such as amplifying noise from areas not related to the test pattern, and incurring a deterioration of the detection accuracy. Accordingly, a background removed image distinguishes test pattern areas which include the test pattern from areas other than this, and the amplification of noise is prevented by performing standardization of only the areas which include the test pattern of the former.

The method which determines whether or not each area is a test pattern area is arbitrary. For example, pixel values may rapidly change at the edge portions of a test pattern, and by paying attention to the dispersion of pixel values which have become high, it may be determined whether or not each area is a test pattern area based on the dispersion values. That is, the characteristic point calculation section 403 acquires dispersion values for each area, and while standardization of luminance is performed if the dispersion values are equal to or more than a threshold, the areas in which the dispersion values are smaller than the threshold do not have standardization performed on them.

Or, by paying attention to the portions irradiated by the test pattern which have a high luminance, it can be determined whether or not each area is a test pattern area based on the average luminance. That is, the characteristic point calculation section 403 acquires an average luminance for each area, and while standardization of luminance is performed if the average luminance is equal to or more than a threshold, the areas in which the average luminance is less than the threshold do not have standardization performed on them. However, in a threshold process of an average luminance, when the irradiation of a test pattern from the projection section 101 and the timing of the shutter of the camera section 104 are not synchronized with each other, it may be necessary to consider that there is a concern with performing a wrong determination for the low luminance areas of the test pattern.

Further, since coordinates of characteristic points such as each point of the four corners from the image after background removal are obtained in the characteristic point calculation section 403, a method is adopted in which two intersecting segments are detected as a straight line or a two-dimensional curved line (that is, an equation of the segments is obtained), and the intersection point of the two segments is calculated.

Information of the background is removed from the first test image and the second test image for a test pattern calculation such as that described above. However, it is assumed that an image after removing the condition of the background is an image in which the contrast of the test pattern is still extremely low, due to the influence of outside light such as natural light. Accordingly, the characteristic point calculation section 403 performs a powerful noise reduction process for images in which information of the background has been removed. For example, a powerful noise reduction process is performed by an autocorrelation of segments, for images in which information of the background has been removed. That is, when an equation of the segments is obtained, an angle of inclination for the segments is detected, and other noise elements can be separated from the segments constituting the test pattern, by averaging a plurality of pixel information of this direction.

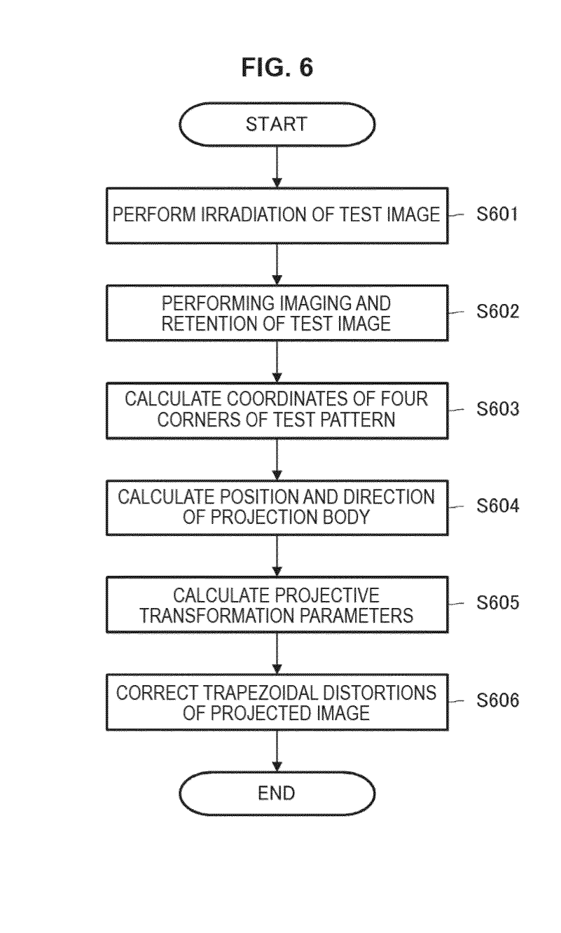

FIG. 6 shows the process procedures, in the form of a flow chart, for correcting distortions of a projected image to the projection body, in the projection-type image display device 100. The process procedures shown in the figure include the following process steps.

S601: Perform irradiation of the test image

S602: Perform imaging and retention of the test image

S603: Calculate coordinates of a plurality of characteristic points within the test pattern

S604: Calculate a position and direction of the projection body, from the coordinates of the plurality of characteristic points within the test pattern

S605: Calculate projective transformation parameters based on the position and direction of the projection body

S606: Correct trapezoidal distortions of the projected image on the projection body by projective transformation

Hereinafter, each of the process steps will be described.

First, a test image, which includes a test pattern generated by the test pattern generation section 305, is irradiated onto a projection body from the projection section 101 (step S601). Then, the camera section 104 images the test image projected onto the projection body, and stores the imaged test image in the imaged image memory 402 (step S602).

As described above, in the present embodiment, in order to remove information of the background from the test image, imaging is performed two times by steps S601 and S602. The following description will describe storing, in the imaged image memory 402, a first test image and a second test image which are imaged at the time when a mutually different first test pattern and second test pattern are respectively irradiated.

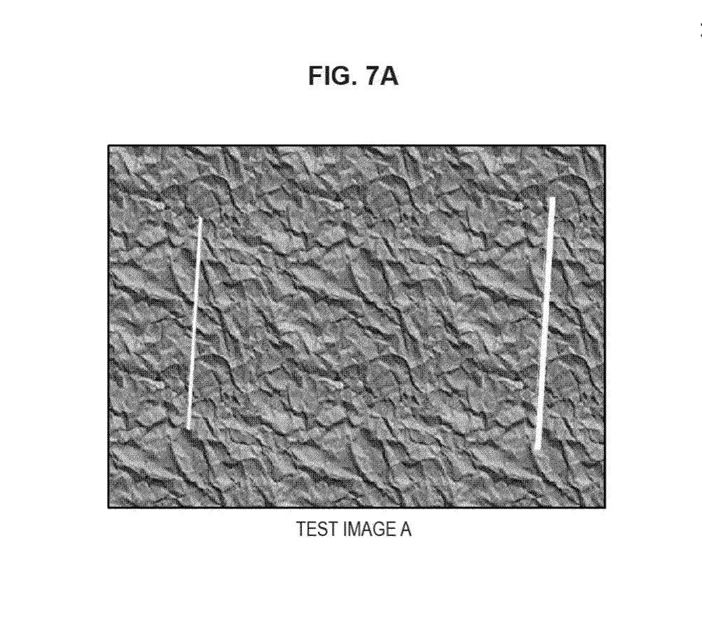

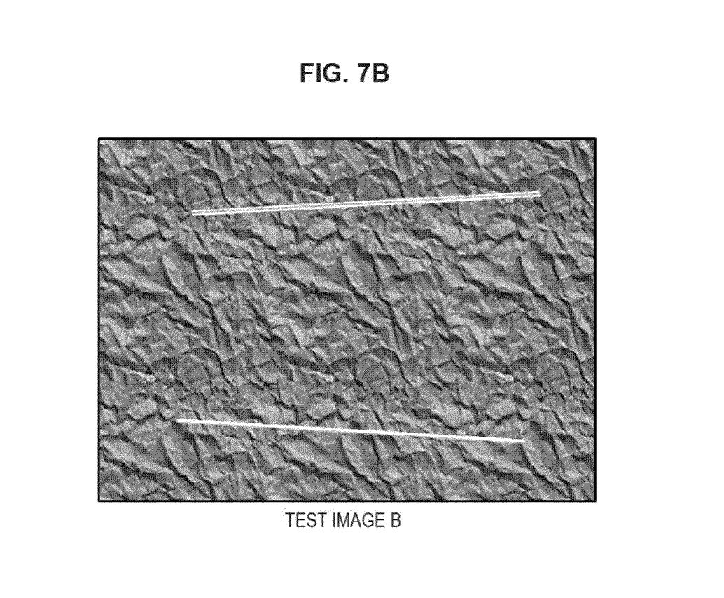

FIG. 7A illustrates a first test image A, which has been imaged by the camera section 104 at the time when a first test pattern constituted of two vertical and horizontal lines along each of the left and right edges of the irradiation range is irradiated onto a projection body from the projection section 101. Further, FIG. 7B illustrates a second test image B, which has been imaged by the camera section 104 at the time when a second test pattern constituted of two vertical and horizontal lines along each of the up and down edges of the irradiation range is irradiated onto a projection body from the projection section 101.

Next, by using the first test image A and the second test image B read from the imaged image memory 402, the characteristic point calculation section 403 obtains coordinates of the four corners of a rectangle, in which the projected first test pattern and the second test pattern are synthesized, as characteristic points of the test pattern included in these imaged images (step S603).

Here, the characteristic point calculation section 403 removes information of the background, by creating a difference between the first test image A and the second test image B, and makes the information of the test pattern clear. Further, after an adjustment is performed by matching the luminance between the first test image A and the second test image B (previously described), the removal of information of the background is performed.

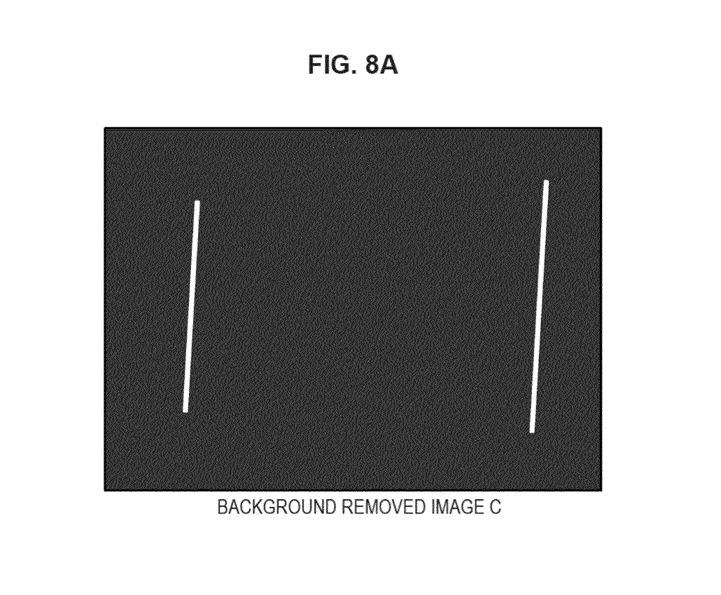

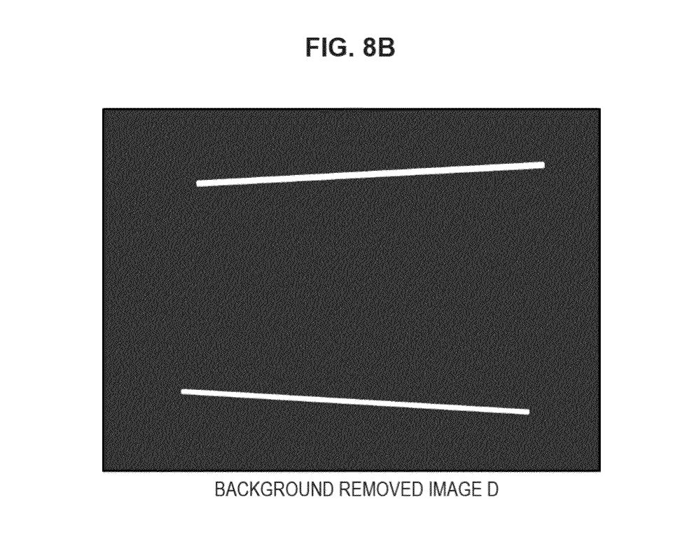

FIG. 8A shows a background removed image C obtained by subtracting the second test image B from the first test image A. In this subtraction process, the second test image B is subtracted from the first test image A in pixel units, and the pixel values are set to 0 in the pixels where the difference is negative. As a result of this, the background disappears from the first test image A in the background removed image C, such as shown in FIG. 8A, and the first test pattern constituted of two vertical lines along each of the left and right edges of the irradiation range remains.

Further, FIG. 8B shows a background removed image D obtained by subtracting the first test image A from the second test image B. In this subtraction process, the first test image A is subtracted from the second test image B in pixel units, and the pixel values are set to 0 in the pixels where the difference is negative. As a result of this, the background disappears from the second test image B in the background removed image D, such as shown in FIG. 8B, and the second test pattern constituted of two horizontal lines along each of the up and down edges of the irradiation range remains.

However, FIG. 8A and FIG. 8B are regarded as results in which the characteristic point calculation section 403 obtains a largest value of luminance for each area of the four segments included in the background removed images C and D, and performs a standardization process of luminance (previously described).

In the case where the test images A and B irradiated in a dark atmosphere are imaged, clear background removed images C and D can be obtained. However, in the case where the test images A and B are imaged in an atmosphere which has been irradiated by outside light such as natural light even by a small amount, only background removed images C and D with a low contrast will be obtained.

Accordingly, the characteristic point calculation section 403 performs a powerful noise reduction process by an autocorrelation of the segments, for the images in which information of the background has been removed.

Vertical lines which have a width will have a strong correlation of the up and down direction even if inclined by a small amount (similarly, horizontal lines which have a width will have a strong correlation of the left and right direction). Therefore, for some pixel line, when an autocorrelation is taken by calculating the total of the pixel values of the same horizontal pixels, in a range of image lines of approximately ±5 lines up and down, the pixel values are amplified approximately 10 times, at the pixel positions near to where the horizontal line passes. On the other hand, since there is only random noise at the pixel positions where the vertical line does not pass, the pixel values are only amplified approximately 3 times even if taking a total of the pixel values for the ±5 lines part. The effect of noise reduction using such an autocorrelation is approximately 3 times.

If the number of pixel lines in which an autocorrelation is taken increases, the effect of noise reduction will be further improved. For example, when the total of the pixel values of a same horizontal pixel position over 100 pixel lines is calculated, the pixel values are amplified to approximately 100 times at the pixel positions near to where the vertical line passes. However, in order to take an autocorrelation of the 100 pixel line part, an error in the angle of segments may have to be within 0.5 degrees.

Accordingly, the effect of noise reduction will be more positively obtained, by combining with technology such as an angle search.

For example, it is possible for the vertical lines of each of the left and right edges, which is the test pattern shown in the right part of FIG. 5B, to be inclined up to a maximum of 13 degrees. Accordingly, first a rough search is performed, in a range of ±13 degrees, for an angle which becomes a largest increase of autocorrelation in one degree intervals. Next, a detailed angle search is performed by an autocorrelation, in a range of 2 degrees near to the angle at which the autocorrelation is the largest by the rough angle search. In this way, when an angle search is repeated three times while reducing the range of the angle search and the interval of the search, the error will be within 0.07 degrees.

In this way, if the angle of the vertical lines, which become a test pattern through a noise reduction process, can be correctly detected, an autocorrelation is taken by obtaining a total of the pixel values of the 100 pixel line part in the actual direction of this angle. Further, standardization is performed by dividing and calculating so that the largest value of the total becomes 255. Since the total of the pixel values is actually taken in 191 pixel lines, the effect of noise reduction is approximately 14 times.

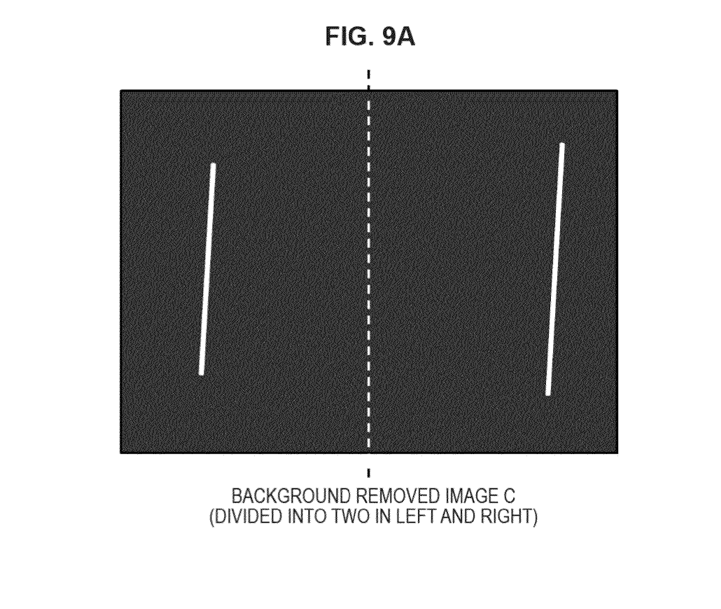

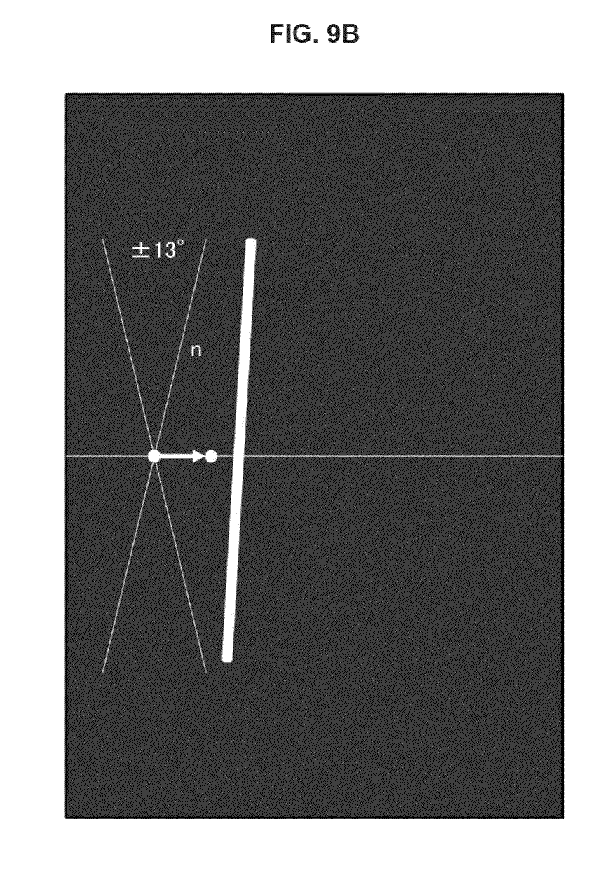

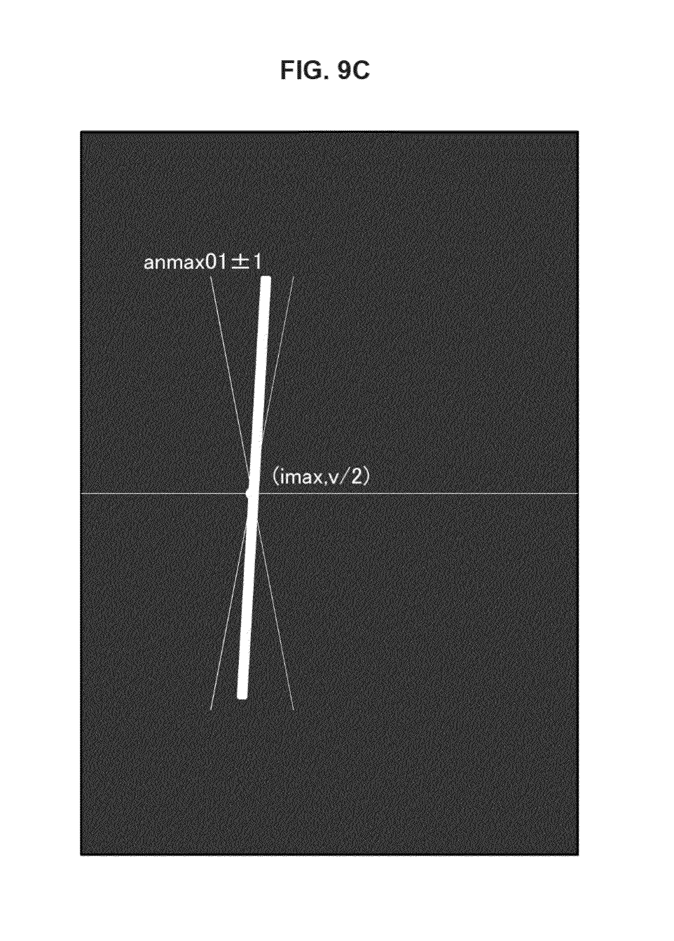

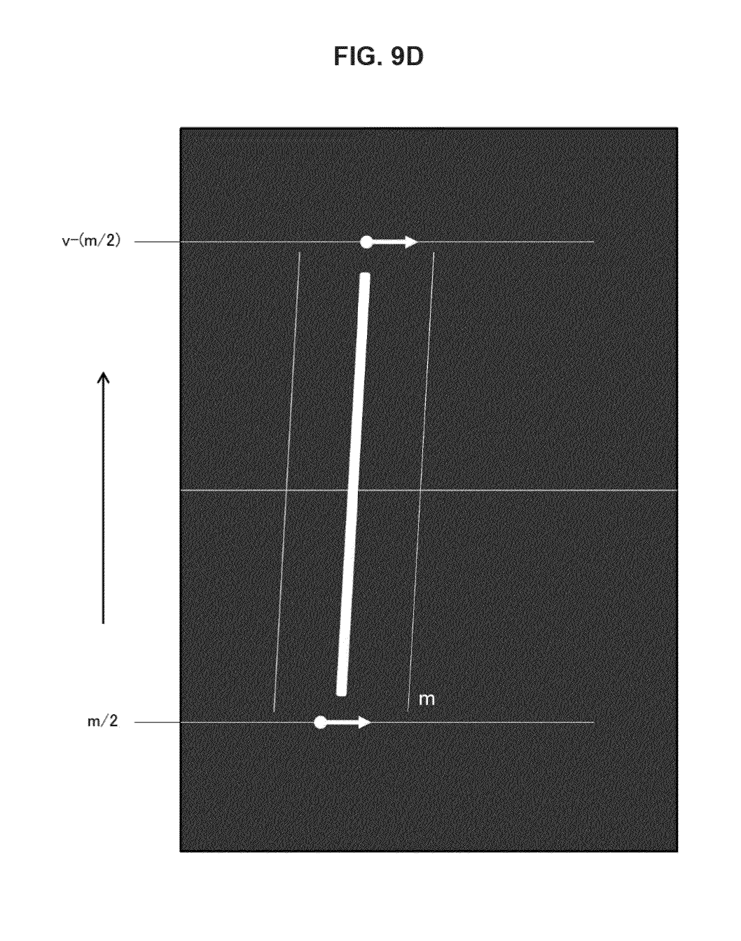

FIGS. 9A to 9D illustrate a state in which an angle search and a noise reduction process are performed for the background removed image C shown in FIG. 8A.

The background removed image C has two vertical lines in the left and right part of each image half. Accordingly, hereinafter, an image such as that shown in FIG. 9A is divided into two left and right parts, and the processes for the image left half will be described. For understanding, the processes for the image right half will be similar to this.

(1) First, an angle is searched while moving one pixel in the horizontal direction, on a line v/2 of the center of a vertical size v. As shown in FIG. 9B, first a range of angles of ±13 degrees (within the figure, the range between the dotted lines) is searched at one degree intervals, and the pixel values of the up and down n pixel part are added.

(2) Then, as a result of the angle search for the sections of angles of ±13 degrees, an angle (anmax01) in which the autocorrelation is the largest, and a pixel position (imax, v/2) are determined, on the line 2/v of the center of the vertical size v.

(3) To continue, such as shown in FIG. 9C, for the determined angle (anmax01), a second angle search is performed at an interval of ¼ degrees, for the range of angles of (anmax01−1) and (anmax01+1) (within the figure, the range between the dotted lines).

(4) Then, additionally for (anmax02), by the angle (anmax02) in which the autocorrelation becomes the largest by the second angle search, a third angle search is performed at an interval of 1/16 degrees, for the range of angles of (anmax02−¼) and (anmax02+¼). By repeating such an angle search three times, the error will be within 0.07 degrees. By the above described processes, an angle (anmax) is determined for the vertical line of the image left half.

(5) To continue, for a range of y=(m/2) to v−(m/2) in the vertical direction (the y direction), such as shown in FIG. 9D, a range of ±15 pixels of the horizontal direction (within the figure, the range between dotted lines) and the pixels of an m pixel part in the vertical direction are averaged, by centering a position x=(y−v/2)×tan(anmax)+imax of the horizontal direction (the x direction), and these are set as pixel values of the position (x,y). Here, within FIG. 9D, an image is completed, in which a noise reduction process is performed, in the range enclosed by the dotted lines.

By also applying the above described processes of (1) to (5) to the image right half, a powerful noise reduction process is implemented by an autocorrelation for the background removed image C. A powerful noise reduction process can be similarly applied by the above described autocorrelation for the background removed image D which includes two horizontal lines shown in FIG. 8B.

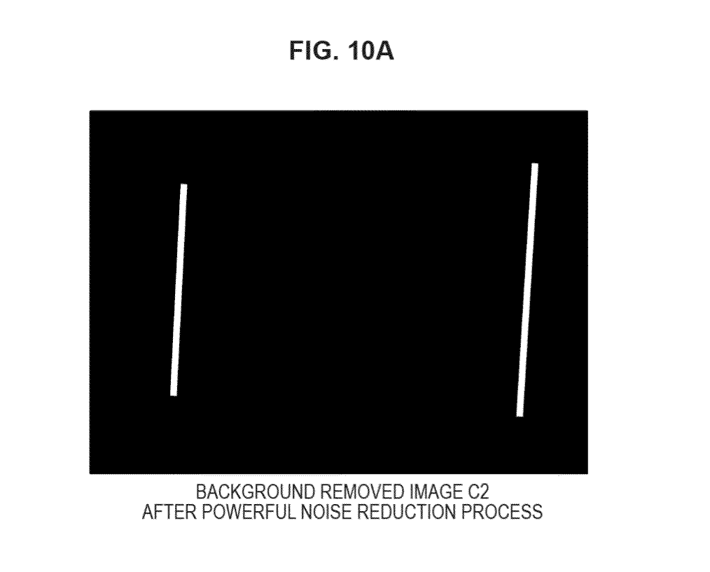

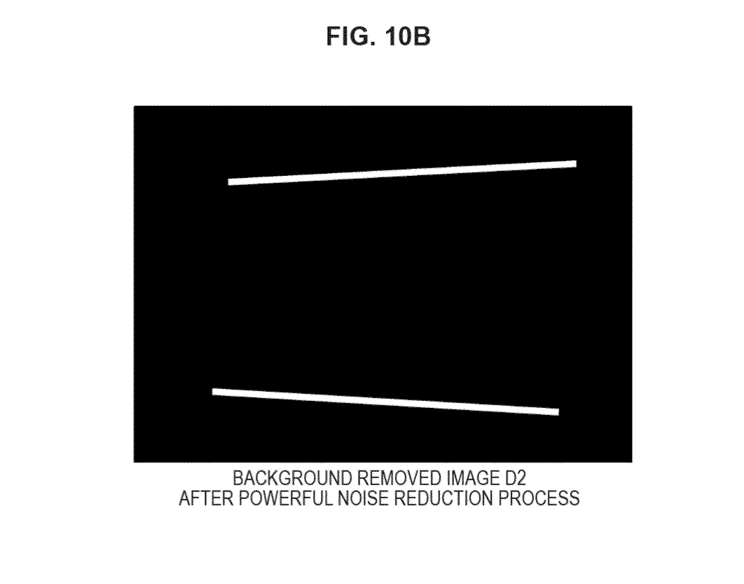

FIG. 10A shows a background removed image C2 which is obtained by performing a powerful noise reduction process by an autocorrelation for the background removed image C shown in FIG. 8A. Further, FIG. 10B shows a background removed image D2 which is obtained by performing a powerful noise reduction process by an autocorrelation for the background removed image D shown in FIG. 8B.

The characteristic point calculation section 403 obtains coordinates of each point of the four corners of the irradiation range of the projection section 101, by calculating intersection points of the two horizontal lines and the two vertical lines included in the background removed images C2 and D2.

Here, if the distortions occurring in the projected image are trapezoidal distortions, the projected image of a test pattern constituted from a combination of vertical lines and horizontal lines is expected to become linear. However, since there are lens distortions in the projection optical section 203 and the camera section 104, these four segments projected onto the projection body (in other words, the segments observed in the background removed images C2 and D2) are small, and they will become a curved line.

Accordingly, the characteristic point calculation section 403 obtains intersection points, by detecting these four segments included in the background removed images C2 and D2 as a two-dimensional curved line.

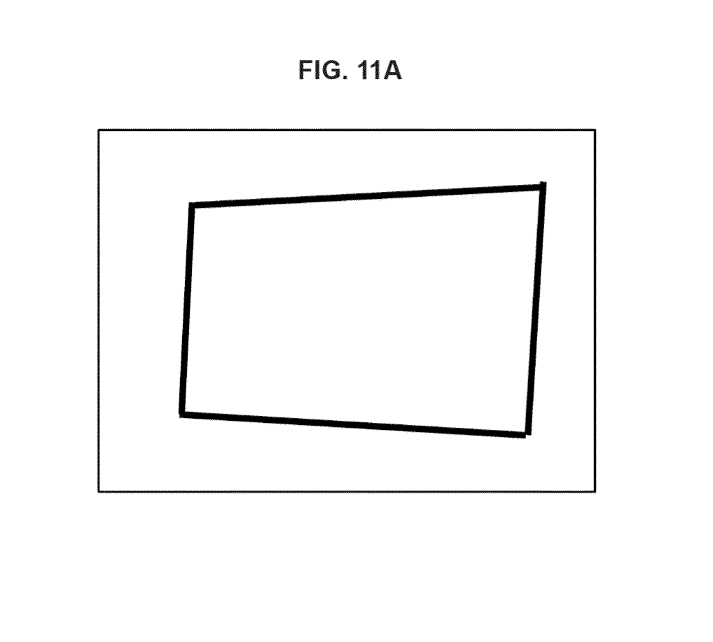

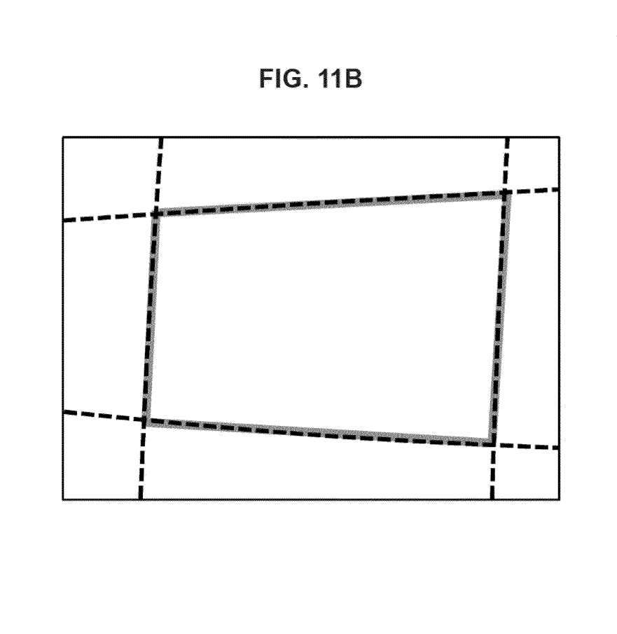

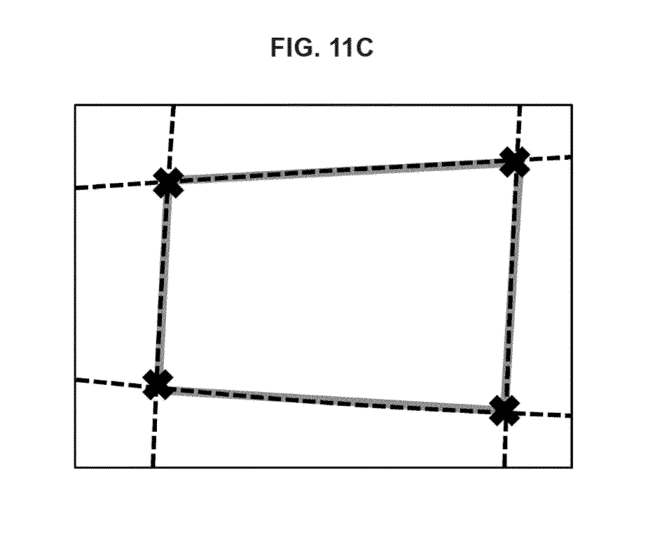

Specifically, the characteristic point calculation section 403 examines the luminance values in an approximately vertical direction for the lines of the background removed images C2 and D2 from the outside towards the center of the image, and sets position data of the segments by using the center of the area which has the highest luminance value from within these. FIG. 11A shows a state in which position data of the segments is extracted from the background removed images. Within this figure, the position data of the segments is drawn by solid lines.

To continue, the characteristic point calculation section 403 calculates, by using a least-squares method, for example, coefficients a, b and c of a two-dimensional curved line y=ax₂+bx+x, which approximates each of the four segments, from this plurality of position data. A least-squares method is used for the detection of the two-dimensional curved line, and the accuracy of one of the number of parts of one pixel can be obtained, by comprehensively handling many points of the segments. FIG. 11B shows a state in which two-dimensional curved lines are detected from two horizontal lines and vertical lines within the background removed images C2 and D2. Within the figure, the two-dimensional curved lines detected from the two horizontal lines and vertical lines are drawn by dotted lines.

Also, the characteristic point calculation section 403 obtains intersection points of the four two-dimensional curved lines, and sets these to the coordinates of the four corners. FIG. 11C shows a state in which the intersection points of four two-dimensional curved lines are obtained. Within the figure, the obtained positions of the four corners are shown by X.

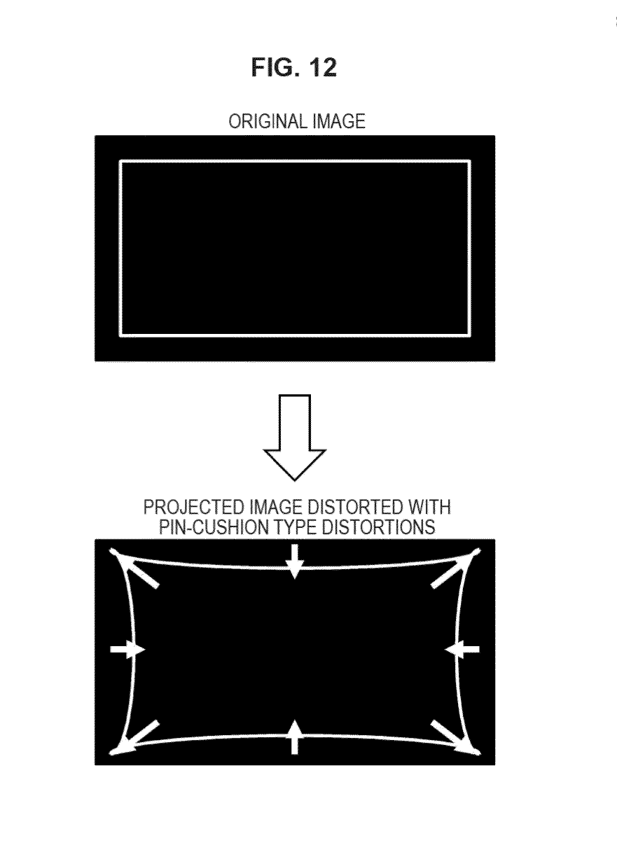

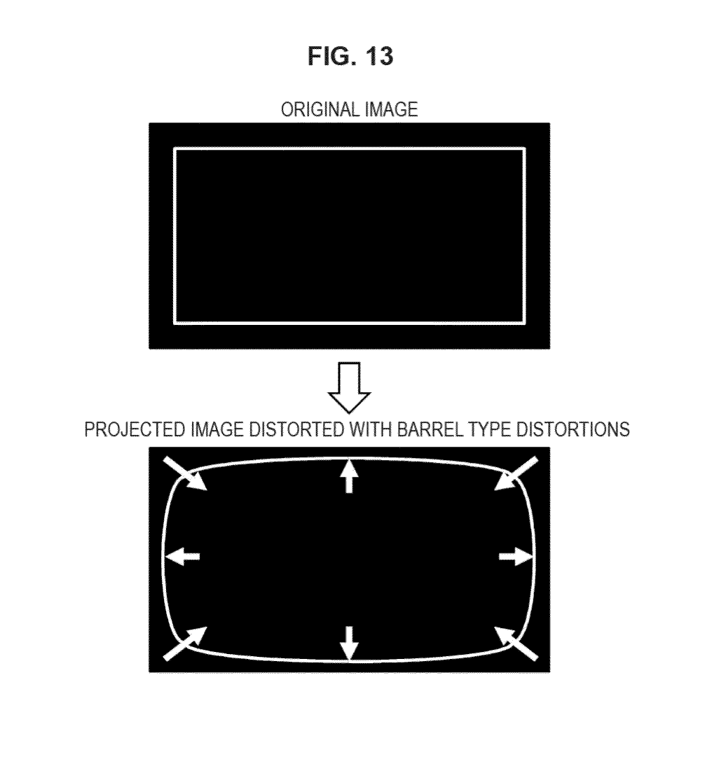

If the distortions occurring in the projected image are trapezoidal distortions, the projected image of a test pattern constituted from a combination of vertical lines and horizontal lines is expected to become linear (previously described), and if performing an angle search with an orientation of 0 degrees in the vertical direction and the horizontal direction, the segments of the test pattern can be detected. However, since there are actually lens distortions in the projection optical section 203 and the camera section 104, and since these test pattern projected onto the projection body has non-linear distortions, there are cases where an optimum solution does not exist within a search range centered on the vertical direction and the horizontal direction. In general, it is known that pin-cushion type distortions which contract at a central position in a viewing field and which expand approximately towards the edges (refer to FIG. 12), and barrel type distortions which expand at the central position in the viewing field and contract approximately towards the edges (refer to FIG. 13), are generated by the projected image due to lens distortions. Distortions of either a pin-cushion type or a barrel type are symmetrical distortion amounts left and right and up and down.

While an optimum solution can be discovered if an angle search is performed by expanding the search range, the computation amount will also increase. In particular, in the case where a detailed mesh shaped test pattern is used such as that shown in FIG. 5G, the computation amount will significantly increase. Further, as shown in FIG. 5G, in the case where a test pattern is used with a small interval between adjacent segments, there is the possibility that an adjacent segment will be mistakenly detected when an angle search is performed by expanding the search range.

Accordingly, an angle search may be performed by adaptively changing the center of the search range, without expanding the search range. Specifically, an angle search is performed by setting, as the center, a result of the adjacent segment to which an angle search has been performed immediately before. This is because it is estimated that changes of the lens distortions are gradual, and changes of the angle between adjacent segments are negligible.

A distortion correction process of the projected image will again be described with reference to FIG. 6. Next, the projective transformation parameter calculation section 404 obtains a distance and direction up to the projection body, based on the coordinates of the four corners calculated such as described above, calculates projective transformation parameters for correcting trapezoidal distortions of an image projected onto the projection body, and outputs the calculated projective transformation parameters to the image correction section (step S604).

Afterwards, the image correction section 303 projects and converts an image read from the frame memory 302, based on the projective transformation parameters received from the correction amount detection section 105, and performs correction such as eliminating trapezoidal distortions when projecting onto a photographic subject from the projection section 101 (step S605).

In this way, according to the projection-type image display device 100 according to the present embodiment, a correction amount is automatically detected based on a projected image of a test pattern imaged by the camera section 104, which is arranged at a position different to that of the irradiation position of the projection section 101, and the image irradiated from the projection section 101 can be corrected so as to be projected onto the projection body by a correct rectangle.

Further, according to the projection-type image display device 100 according to the present embodiment, since a powerful noise reduction process is performed by an autocorrelation for the projected image of the test pattern projected by the camera section 104, accurate coordinates of the four corners can be obtained by removing an influence of the background due to outside light such as natural light. Therefore, the projection-type image display device 100 can be used not only in a dark room but also in a light room, and further, can be corrected so that an image irradiated from the projection section 101 is projected onto the projection body by a correct rectangle.

Additionally, the present technology may also be configured as below.

(1) A projection-type image display device, including:

a projection section configured to project an image onto a projection body;

a camera section, provided at a position different to an irradiation position of the projection section, configured to image the image projected onto the projection body;

a correction amount detection section configured to remove a background from a test image imaged by the camera section at a time when a test pattern is projected onto the projection body from the projection section, detect information of coordinates related to the test pattern within the test image after background removal, and calculate correction parameters for correcting the image projected from the projection section based on the information of the coordinates; and

an image correction section which corrects the image projected from the projection section based on the correction parameters.

(2) The projection-type image display device according to (1),

wherein the correction amount detection section calculates coordinates of a plurality of characteristic points of the test pattern from the test image after background removal, and calculates, from the coordinates of the plurality of characteristic points, projective transformation parameters for correcting distortions included in the projected image of the photographic subject, and

wherein the image correction section performs projective transformation on the image projected from the projection section by the projective transformation parameters.

(3) The projection-type image display device according to (1),

wherein the camera section images a first test image at a time when the test pattern is not irradiated from the projection section, and images a second test image at the time when the test pattern is irradiated from the projection section, and

wherein the correction amount detection section removes information of a background from the second test image, by creating a difference between the first test image and the second test image, and obtains the test image after background removal in which the test pattern is included.

(4) The projection-type image display device according to (1),

wherein the camera section images a first test image at a time when a first test pattern is irradiated from the projection section, and images a second test image at a time when a second test pattern is irradiated from the projection section, and

wherein the correction amount detection section removes information of a background from the first test image and the second test image, by creating a difference between the first test image and the second test image, and obtains the test image after background removal including a test pattern in which the first test pattern and the second test pattern are synthesized.

(5) The projection-type image display device according to (3) or (4),

wherein the correction amount detection section performs a removal process of information of a background after performing an illuminance adjustment between the first test image and the second test image.

(6) The projection-type image display device according to (5),

wherein the correction amount detection section performs the luminance adjustment process by multiplying a ratio of an average luminance based on one of the first test image and the second test image by pixel values of the other image.

(7) The projection-type image display device according to (6),

wherein the correction amount detection section performs the luminance adjustment process for each area in which the first test image and the second test image are divided into a horizontal and a vertical direction, respectively.

(8) The projection-type image display device according to (1),

wherein the correction amount detection section standardizes luminance for areas which include the test pattern from within the test image after background removal.

(9) The projection-type image display device according to (8),

wherein the correction amount detection section standardizes luminance only for areas in which dispersion values of pixel values from within the test image are equal to or more than a prescribed threshold.

(10) The projection-type image display device according to (5),

wherein a mesh shaped test pattern is used which includes a plurality of vertical lines and a plurality of horizontal lines,

wherein the correction amount detection section calculates projective transformation parameters for correcting distortions based on coordinates of a plurality of characteristic points including each intersection point of vertical lines and horizontal lines of the test pattern included in the test image after background removal, and

wherein the image correction section performs projective transformation on the image projected from the projection section by the projective transformation parameters.

(11) The projection-type image display device according to (10),

wherein the test pattern further includes two slits corresponding to diagonal lines of a rectangle which becomes an outline of the test pattern.

(12) The projection-type image display device according to (10),

wherein the correction amount detection section estimates a largest image size which can be projected onto the projection body from the projection section based on coordinates of characteristic points which can be detected from the test image after background removal.

(13) The projection-type image display device according to (4),

wherein a first test pattern including a plurality of vertical lines and a second test pattern including a plurality of horizontal lines are used,

wherein the correction amount detection section calculates projective transformation parameters for correcting distortions based on coordinates of a plurality of characteristic points including each intersection point of vertical lines and horizontal lines of the test pattern included in the test image after background removal, and

wherein the image correction section performs projective transformation on the image projected from the projection section by the projective transformation parameters.

(14) In the projection-type image display device according to (13),

wherein the first test pattern and the second test pattern each include two slits which correspond to the diagonal lines of a rectangle which becomes an outline of the above described test pattern.

(15) The projection-type image display device according to (13),

wherein the correction amount detection section estimates a largest image size which can be projected onto the projection body from the projection section based on coordinates of characteristic points which can be detected from the test image after background removal.

(16) The projection-type image display device according to (1),

wherein after performing a noise reduction process by additional autocorrelation for a test image after information of a background is removed, the correction amount detection section detects information of coordinates of each characteristic point related to the test pattern within the test image, and calculates correction parameters based on information of the coordinates of each characteristic point.

(17) The projection-type image display device according to (16),

wherein after performing a noise reduction process by angle searching the test image including the test pattern of a plurality of vertical lines or a plurality of horizontal lines in a vertical direction or a horizontal direction, the correction amount detection section calculates coordinates of a plurality of characteristic points including each intersection point of vertical lines and horizontal lines of the test pattern, and calculates projective transformation parameters for correcting distortions based on information of the coordinates of each intersection point.

(18) The projection-type image display device according to (17),

wherein the correction amount detection section detects each test pattern of vertical lines or horizontal lines included in the test image as a two-dimensional curved line.

(19) The projection-type image display device according to (17),

wherein the correction amount detection section performs an angle search by setting, as a center, a result of an adjacent segment to which an angle search has been performed immediately before.

(20) An image projection method, including:

projecting a test pattern onto a projection body;

acquiring a test image by imaging the test pattern projected onto the projection body;

removing a background from the test image;

detecting information of coordinates related to the test pattern included in the test image after background removal, and calculating correction parameters for correcting an image projected from a projection section based on information of the coordinates; and

correcting the projected image based on the correction parameters.

(21) A computer program written in a computer-readable format so as to cause a computer to execute:

projecting a test pattern onto a projection body;

acquiring a test image by imaging the test pattern projected onto the projection body;

removing a background from the test image;

detecting information of coordinates related to the test pattern included in the test image after background removal, and calculating correction parameters for correcting an image projected from a projection section based on information of the coordinates; and

correcting the projected image based on the correction parameters.

Heretofore, the technology described in the present disclosure has been described in detail while referring to the specific embodiments. However, it is evident that a person skilled in the art can perform corrections or substitutions in a range which does not deviate from the content of the technology described in the present disclosure.

In the present disclosure, while embodiments related to a projection-type image display device of an integrated camera have been described, technology similar to that described in the present disclosure can be applied, even in the case where a camera is included so as to be detachable from the projection-type image display device or connected externally to the main body.

It should be understood by those skilled in the art that various modifications, combinations, sub-combinations and alterations may occur depending on design requirements and other factors insofar as they are within the scope of the appended claims or the equivalents thereof.

What is claimed is:

1. A projection-type image display device, comprising:
a projection section configured to project an image onto a projection body;
a camera section, provided at a position different to an irradiation position of the projection section, configured to image the image projected onto the projection body;
a correction amount detection section configured to remove a background from a test image imaged by the camera section at a time when a test pattern is projected onto the projection body from the projection section, detect information of coordinates related to the test pattern within the test image after background removal, and calculate correction parameters for correcting the image projected from the projection section based on the information of the coordinates; and
an image correction section which corrects the image projected from the projection section based on the correction parameters.

2. The projection-type image display device according to claim 1,
wherein the correction amount detection section calculates coordinates of a plurality of characteristic points of the test pattern from the test image after background removal, and calculates, from the coordinates of the plurality of characteristic points, projective transformation parameters for correcting distortions included in the projected image of the photographic subject, and
wherein the image correction section performs projective transformation on the image projected from the projection section by the projective transformation parameters.

3. The projection-type image display device according to claim 1,
wherein the camera section images a first test image at a time when the test pattern is not irradiated from the projection section, and images a second test image at the time when the test pattern is irradiated from the projection section, and
wherein the correction amount detection section removes information of a background from the second test image, by creating a difference between the first test image and the second test image, and obtains the test image after background removal in which the test pattern is included.

4. The projection-type image display device according to claim 1,
wherein the camera section images a first test image at a time when a first test pattern is irradiated from the projection section, and images a second test image at a time when a second test pattern is irradiated from the projection section, and
wherein the correction amount detection section removes information of a background from the first test image and the second test image, by creating a difference between the first test image and the second test image, and obtains the test image after background removal including a test pattern in which the first test pattern and the second test pattern are synthesized.

5. The projection-type image display device according to claim 3,
wherein the correction amount detection section performs a removal process of information of a background after performing an illuminance adjustment between the first test image and the second test image.

6. The projection-type image display device according to claim 5,
wherein the correction amount detection section performs the luminance adjustment process by multiplying a ratio of an average luminance based on one of the first test image and the second test image by pixel values of the other image.

7. The projection-type image display device according to claim 6,
wherein the correction amount detection section performs the luminance adjustment process for each area in which the first test image and the second test image are divided into a horizontal and a vertical direction, respectively.

8. The projection-type image display device according to claim 1,
wherein the correction amount detection section standardizes luminance for areas which include the test pattern from within the test image after background removal.

9. The projection-type image display device according to claim 8,
wherein the correction amount detection section standardizes luminance only for areas in which dispersion values of pixel values from within the test image are equal to or more than a prescribed threshold.

10. The projection-type image display device according to claim 3,
wherein a mesh shaped test pattern is used which includes a plurality of vertical lines and a plurality of horizontal lines,
wherein the correction amount detection section calculates projective transformation parameters for correcting distortions based on coordinates of a plurality of characteristic points consisting of each intersection point of vertical lines and horizontal lines of the test pattern included in the test image after background removal, and
wherein the image correction section performs projective transformation on the image projected from the projection section by the projective transformation parameters.

11. The projection-type image display device according to claim 10,
wherein the test pattern further includes two slits corresponding to diagonal lines of a rectangle which becomes an outline of the test pattern.

12. The projection-type image display device according to claim 10,
wherein the correction amount detection section estimates a largest image size which can be projected onto the projection body from the projection section based on coordinates of characteristic points which can be detected from the test image after background removal.

13. The projection-type image display device according to claim 4,
wherein a first test pattern including a plurality of vertical lines and a second test pattern including a plurality of horizontal lines are used,
wherein the correction amount detection section calculates projective transformation parameters for correcting distortions based on coordinates of a plurality of characteristic points consisting of each intersection point of vertical lines and horizontal lines of the test pattern included in the test image after background removal, and
wherein the image correction section performs projective transformation on the image projected from the projection section by the projective transformation parameters.

14. The projection-type image display device according to claim 13,
wherein the correction amount detection section estimates a largest image size which can be projected onto the projection body from the projection section based on coordinates of characteristic points which can be detected from the test image after background removal.

15. The projection-type image display device according to claim 1,
wherein after performing a noise reduction process by additional autocorrelation for a test image after information of a background is removed, the correction amount detection section detects information of coordinates of each characteristic point related to the test pattern within the test image, and calculates correction parameters based on information of the coordinates of each characteristic point.

16. The projection-type image display device according to claim 15,
wherein after performing a noise reduction process by angle searching the test image including the test pattern of a plurality of vertical lines or a plurality of horizontal lines in a vertical direction or a horizontal direction, the correction amount detection section calculates coordinates of a plurality of characteristic points consisting of each intersection point of vertical lines and horizontal lines of the test pattern, and calculates projective transformation parameters for correcting distortions based on information of the coordinates of each intersection point.

17. The projection-type image display device according to claim 16,
wherein the correction amount detection section detects each test pattern of vertical lines or horizontal lines included in the test image as a two-dimensional curved line.

18. The projection-type image display device according to claim 16,
wherein the correction amount detection section performs an angle search by setting, as a center, a result of an adjacent segment to which an angle search has been performed immediately before.

19. An image projection method, comprising:
projecting a test pattern onto a projection body;
acquiring a test image by imaging the test pattern projected onto the projection body;
removing a background from the test image;
detecting information of coordinates related to the test pattern included in the test image after background removal, and calculating correction parameters for correcting an image projected from a projection section based on information of the coordinates; and
correcting the projected image based on the correction parameters.

20. A computer program written in a computer-readable format so as to cause a computer to execute:
projecting a test pattern onto a projection body;
acquiring a test image by imaging the test pattern projected onto the projection body;
removing a background from the test image;
detecting information of coordinates related to the test pattern included in the test image after background removal, and calculating correction parameters for correcting an image projected from a projection section based on information of the coordinates; and
correcting the projected image based on the correction parameters.
